(19) United States
(12) Patent Application Publication
(10) Pub. No.: US 2006/0193527 A1
(43) Pub. Date: Aug. 31, 2006

(54) System and methods of mode determination for video compression

(75) Inventors: Hari Kalva, Delray Beach, FL (US); Branko Petljanski, Boca Raton, FL (US)

Correspondence Address: AKERMAN SENTERFITT, P.O. BOX 3188, WEST PALM BEACH, FL, 33402-3188, US

(73) Assignee: Florida Atlantic University, Boca Raton, FL (US)

(21) Appl. No.: 11/329,602

(22) Filed: Jan. 11, 2006

Related U.S. Application Data
(60) Provisional application No. 60/643,042, filed on Jan. 11, 2005.

(51) Int. Cl. G06K 9/36

(52) U.S. Cl. 382/239

(57) ABSTRACT

A system for transcoding a video file is provided. The system includes a video file decoder for generating an uncompressed file segment based upon a received compressed video file compressed according to a first data compression standard. The system additionally includes one or more macroblock (MB) determining modules for determining an MB mode based upon coefficients generated by the decoding of the compressed video file. The system further includes a video file encoder for compressing the uncompressed file segment according to a second data compression standard based on the determined MB mode.

### CROSS-REFERENCE TO RELATED APPLICATIONS

This application claims the benefit of U.S. Provisional Application No. 60/643,042, filed in the United States Patent and Trademark Office on Jan. 11, 2005, the entirety of which is incorporated herein by reference.

### BACKGROUND

1. Field of the Invention

The present invention is related to the field of video compression, and, more particularly, to encoding and transcoding video files.

2. Description of the Related Art

The communication and entertainment industries have both been profoundly changed by advances in digital technology. Broadcast television and home entertainment, for example, have been fundamentally redefined by the advent of digital TV and DVD-video. Much of the advancement can be directly attributed to techniques for handling video files using ever-newer coding algorithms for video compression. The MPEG-2 video coding algorithm, for example, is the standard for much if not most video currently used in digital entertainment applications. The MPEG-4, a more recent addition in the MPEG series, meanwhile, has been enabling a new generation of Internet-based video applications and is often used with mobile phones. Another standard is the ITU-T H.263 standard for video compression that has been widely used in videoconferencing systems. It is now anticipated by many that an even newer standard, the H.264 standard, will soon be appearing in many mobile devices, especially since it offers substantial bandwidth and quality advantages.

It is reasonable to expect that newer standards will continue to emerge, offering ever-greater advantages like the improved bandwidth and quality of the H.264 standard. These advantages make the H.264 standard and others that may emerge desirable candidates for use in a wide array of applications, including high-bit-rate and high-quality digital video applications such as digital TV and DVD-video, as well as in lower-bit-rate applications such as video delivery to mobile phones and similar such devices. One problem remains largely unresolved, however. The problem lies in the inherent differences in the computational and communicational resources of different end-user devices. These differences may preclude the use of the same encoded video or other data content for all applications.

For example, the high bit rate that may be well suited for digital TV broadcast is typically not suited for streaming video to a mobile phone or other mobile terminal. The more limited resources of a mobile phone or other mobile terminal will likely impose a limitation on the bit rate and resolution of video content that such terminals can accommodate. Accordingly, it is likely that a lower bit rate and lower resolution for such mobile devices will be needed as compared to other devices.

One proposed solution is pre-encoding of video. But pre-encoding video bit streams can result in device inefficiencies. This can be especially problematic given that different devices typically have different capabilities, and the differences can vary widely among different devices. This may make it all but impossible to pre-encode video bit streams so as to accommodate all the different capabilities offered by different devices. Moreover, device resources, including data processing and powering resources, as well as bandwidth availability, may vary during a data session. Therefore, a pre-encoded video stream many not be able to accommodate the dynamic resource changes that may occur during a particular session.

An alternative to pre-encoding is transcoding. Transcoding is intended to permit the use of all or most of a device's capabilities. Transcoding can be effected with a transcoder for such applications, the transcoder taking as input a high-bit-rate video file, for example, and transcoding the video to a lower bit rate and/or lower resolution video suitable for a particular device, such as a mobile phone or other mobile terminal. Nonetheless, transcoding can often involve considerable complexity, which, in turn, can necessitate that the transcoder itself be considerably complex. It follows that there is yet need for an efficient device or technique that overcomes the persistent problems associated with transcoding.

### SUMMARY OF THE INVENTION

The present invention provides a system and related methods for computing macroblock (MB) coding modes and intra-MB prediction modes. The present invention, moreover, provides a system and related methods for determining MB coding and prediction modes. The reduced complexity of the procedures for computing the MB coding and prediction modes, according to the present invention, can be used to achieve more efficient transcoding of digital video. The reduced complexity can also reduce the resources required for effecting digital video compression.

One embodiment of the present invention is a system for transcoding a video file. The system can include a video file decoder for generating an uncompressed file segment based upon a received compressed video file that has been compressed according to a first data compression standard. Additionally, the system can include at least one MB determining module for determining an MB mode based upon at least one of a plurality of coefficients generated through the decoding of the compressed video file. The system further can include a video file encoder for compressing the uncompressed file segment according to a second data compression standard based upon the determined MB mode.

Another embodiment of the present invention is a method of determining an inter-MB coding mode for encoding a video file. The method can include the step of obtaining a plurality of coefficients by decoding a compressed video file. Additionally, the method can include the step of computing a mean energy metric based upon the plurality of coefficients. The method also can include computing a standard deviation metric based upon the plurality coefficients. The method can further include determining the MB coding mode based upon the mean energy and standard deviation metrics.

Yet another embodiment of the present invention is a method of determining an intra-MB coding mode for encoding a video file. The method can include the step of obtaining a plurality of discrete cosine transformation (DCT) coefficients by decoding a compressed video file. The method further can include the steps of computing a mean energy metric based upon the plurality of DCT coefficients and computing a standard deviation metric also based upon the plurality of DCT coefficients. The method additionally can include determining the MB coding mode based upon the mean energy and standard deviation metrics.

Still another embodiment of the present invention is a method for determining an intra-MB prediction mode for encoding a video file. The method can include obtaining a plurality of coefficients by decoding a compressed video file. The method also can include computing an edge angle metric based upon the plurality of coefficient. The method further can include determining the intra-MB prediction mode based upon the edge angle metric.

### BRIEF DESCRIPTION OF THE DRAWINGS

There are shown in the drawings, embodiments which are presently preferred, it being understood, however, that the invention is not limited to the precise arrangements and instrumentalities shown.

FIG. 1 is a schematic diagram of a system for transcoding a data file, according to one embodiment of the present invention.

FIG. 2 is a flowchart of exemplary steps of a method of determining an MB coding mode and an MB prediction mode, according to another embodiment of the present invention.

FIG. 3 is a schematic diagram of a system for determining an MB coding mode and an MB prediction mode, according to yet another embodiment of the present invention.

FIG. 4 is a schematic diagram of a system for determining an inter-MB coding mode, according to still another embodiment of the present invention.

FIG. 5 is a flowchart of exemplary steps of a method of determining an inter-MB coding mode, according to still another embodiment of the present invention.

### DETAILED DESCRIPTION OF THE INVENTION

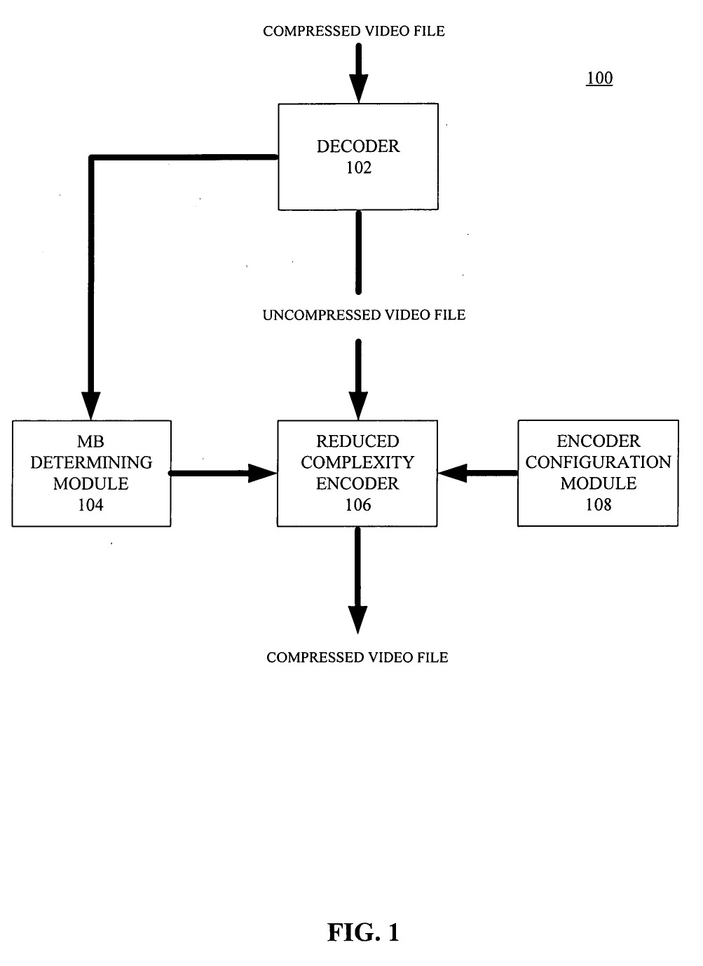

FIG. 1 is a schematic diagram of a system 100, according to one embodiment of the present invention, that efficiently transcodes a video file. A video file, as will be readily understood by one of ordinary skill in the art, is a data file containing machine-readable data for rendering a video presentation on a display screen. A data representation of a video segment can be encoded as a set of macroblocks (MBs), one video frame at a time. As described herein, the system 100 can determine, jointly and singly, MB coding modes and intra-MB prediction modes in order to effect an efficient transcoding of a video file.

The system 100 illustratively includes a video decoder 102, an MB determining module 104 communicatively linked to the video decoder, and a video encoder 106 communicatively linked to both the video decoder and MB determining module. Illustratively, the system 100 further includes an encoder configuration module 108 communicatively linked to the video encoder 106. Each of the modules of the system 100 can be implemented as a set of machine-readable instructions, dedicated hardwired circuitry, or a combination of machine-readable instructions and hardwired circuitry

Operatively, the video decoder 102 receives a video file that comprises a compressed video file that has undergone a process of video compression according to a first compression standard. For example, the compressed video file can be video file compressed according to a discrete cosine transform (DCT)-based video coding algorithm, such as the MPEG-2 video coding algorithm. The video decoder 102 decompresses the received compressed video file, thereby generating an uncompressed data segment based upon the received compressed video file.

The MB determining module 104 according to one embodiment determines an MB coding mode according to the procedures described herein. The MB determining module 104, according to another embodiment, determines an intra-MB prediction mode according to other procedures described herein. According to still another embodiment, the MB determining module 104 jointly determines both an intra-MB coding mode as well as an intra-MB prediction mode. With the appropriate MB mode having been determined by the MB determining module 104, the video encoder 106 compresses the uncompressed file segment according to a second video compression standard based on the determined MB mode. The second video compression standard, for example, is the H.264 standard. The second video compression standard is illustratively provided by the encoder configuration module 108, which is communicatively connected to the video encoder 106. The resulting video segment generated by the video encoder 106 is therefore a compressed video segment, the compression being based upon the second video compression standard, such as the H.264 standard.

More particularly, the MB coding mode and intra-MB prediction mode can be separately or jointly determined by the MB determining module 104 based upon a plurality of DCT coefficients, as described more particularly below. A DCT, as will be readily understood by one of ordinary skill in the art, is a Fourier-related transform similar to the discrete Fourier transform (DFT) but based on only real numbers. Alternatively, or additionally, the MB coding mode and intra-MB prediction mode can singly or jointly determined by the MB determining module 104 based upon a plurality of motion vectors, and/or plurality of residual coefficients, as also described more particularly below.

An MB used in video coding can, according to standard conventions, correspond to a 16×16 array of luma pixels and corresponding chroma pixels. The MB coding mode indicates the type of prediction and/or block size used to compress the MB. In general, the MB can be coded as an intra-MB, which does not use temporal prediction, or an inter-MB, which uses temporal prediction. A number of different intra- and inter-MB coding modes are possible. For example, in H.264 video coding, the luma component of an intra-MB can be coded as one 16×16 block, as four 8×8 sub-blocks or as sixteen 4×4 sub-blocks.

Each of the sub-blocks can use one of nine available prediction modes. Four prediction modes can be provided for a 16×16 block. Similarly for inter-MBs, an MB coding type can use a number of different block sizes, each representing a different MB coding mode. The H.264 video coding standard allows variable block sizes for motion estimation, and each MB can be coded in one of the several alternative modes. As the number of available coding modes increase, finding the optimal mode requires an increasing amount of computing resources. As will be apparent from the discussion herein, the system 100 can reduce this computational complexity relative to conventional devices and methods.

According to one embodiment of the present invention, the plurality of DCT coefficients, described above, are obtained as a by-product of the decoding of a video bit stream compressed according to a DCT-based video coding algorithm, such as those based on the MPEG-2, MPEG-4, H.263, or H.264 standards. According to still another embodiment, if only residual DCT coefficients are obtainable (e.g., if the video coding corresponds to inter-coded MPEG-2 blocks), then full DCT coefficients can be constructed using the motion compensated DCT manipulation proposed by S. F. Chang and D. G. Messerschmitt, “Manipulation and Composting of MC-DCT Compressed Video,” IEEE Journal of Selected Areas in Communications, Vol. 13, pp. 1-11 (January 1995), which is incorporated herein in its entirety. According to still another embodiment, if only residual DCT coefficients are obtainable (e.g., if the video coding corresponds to inter-coded MPEG-2 blocks), the coding modes are computed using the residuals or the residuals after applying the inverse DCT.

More particularly, for a video file encoded, for example, according to the MPEG-2 standard, the decoding by the video decoder 102 yields an n×n block, f(x,y), and a corresponding plurality of DCT coefficients, F(u,v), where F(u,v) is the (u,v)-th DCT coefficient and f(x,y) is the (x,y)-th pixel of a sub-block of a corresponding MB The MB determining module 104 determines an MB coding mode and/or MB prediction mode based one or more metrics, each of the one or more metrics can be determined based upon the DCT coefficients, F(u,v), obtained during the decoding process according to one embodiment.

A first exemplary metric is an edge angle. The edge angle corresponds to the tangent of an ideal edge passing through the center of the n×n block. As shown, for example, in B. Schen and I. K. Sethi, “Direct Feature Extraction From Compressed Images,” Proc. SPIE Storage and Retrieval for Image and Video Databases IV, Vol. 2670, (1966), incorporated herein in its entirety, the ratio of the vertical energy of the block to the horizontal energy of the block yields the tangent of the ideal edge passing through the center of the block. More particularly, according to one embodiment, the edge angle, θ, is determined according to the following calculation:

$$tan θ = \frac{{\sum }_{u = 1}^{n} \vert F ( u , 0 ) \vert}{{\sum }_{v = 1}^{m} \vert F ( 0 , v ) \vert} , m , n < N ,$$

where N is the size of the block.

A second exemplary metric is the average energy of the block. The average energy, according to one embodiment, is determined according to the following calculation, where F(0,0) is proportional to the mean energy and provides an estimate of the average energy, μ, of the n×n block:

$$μ = \frac{1}{{n}^{2}} {\sum }_{0}^{n - 1} {\sum }_{0}^{n - 1} f ( x , y ) = \frac{F ( 0 , 0 )}{n} + K ,$$

where K is a constant used for optional level shifting. For example, K equals 128 for MPEG-2 intra-coded MBs.

A third exemplary metric is a standard deviation. The standard deviation, σ², is illustratively based upon the following calculation:

$${σ}^{2} = \frac{1}{{n}^{2}} {\sum }_{u = 0}^{n - 1} {\sum }_{v = 0}^{n - 1} {F ( u , v )}^{2} , ( u , v ) \neq ( 0 , 0 ) ,$$

where each F(u,v) designates a corresponding one of the plurality of DCT coefficients as described above. A simplified computation of the variance is based upon only a subset of coefficients, e.g., the horizontal and vertical coefficients. The computation can also be used in mode estimation.

A fourth exemplary metric is the mean and variance of a motion-compensated (MC) residual, the residual being the difference between an actual value and predicted value. The mean and variance can be calculated for the MC residual for the 16×16 block or sub-block of different sizes such as 4×4 blocks. The mean and variance can be calculated using the DCT of the MC residual or the MC residual after an inverse DCT is computed.

According to one embodiment, the MB determining module 104 uses computed metrics, such as those defined above, to determine or select an H.264 intra-prediction mode. The H.264 video coding standard defines nine intra-prediction modes, designated modes 0 through 8, for 8×8 and 4×4 luma blocks. A total of 4 modes, modes 0 through 3, are defined for 16×16 blocks and chroma blocks. Exhaustively evaluating all these modes to find an optimum mode is computationally intensive. To reduce the complexity of finding the optimum mode, the MB determining module 104 compares one or more computed metrics to one or more threshold values and select modes based on the comparison.

For example, in selecting an H.264 coding mode, the MB determining module 104 compares the estimated variance or standard deviation to predetermined thresholds. If the estimated variance or standard deviation is low (i.e., below a predetermined threshold), the block prediction mode is selected as the intra 16×16 mode. Conversely, for example, if the estimated variance or standard deviation is above the predetermined threshold, then an intra 4×4 mode is selected. Moreover, according to another embodiment, with an additional threshold, an estimated variance or standard deviation between the two thresholds would dictate selection of an intra 8×8 mode.

Similarly, in selecting a prediction mode, if an estimated edge angle is less than 10 degrees, the mode selected is mode 0, a vertical mode. If the estimated angle is greater than 80 degrees, the mode selected is the horizontal prediction mode. Similarly, modes 3 to 8 are predicted based on the edge angle and the sign of the coefficients. The dc mode, according to the standard, is one of the prediction modes (also designated as mode 2) and can also be estimated by comparing how close the mean energy of the block, computed using the DCT coefficient, is to the mean energy of the pixels from the neighboring blocks that are used in forming the predictions.

The following pseudo code illustrates an intra-mode estimation for modes 0 to 8:

nRowSum = nColSum = 0;
dblk[64]; is an array of 64 DCT coefficients corresponding to the DCT of an 8x8 block.
for(j = 1; j < 8; j++){

nRowSum = nRowSum + abs(dblk[j]);
nColSum = nColSum + abs(dblk[j*8]);

}
// general orientation
if(nColSum > nRowSum){

hor = 1; // horizontally dominant
// polarity
if((dblk[1] <0 && dblk[8] <0) || (dblk[1] > 0 && dblk[8] > 0)){

mode = 8;

}else{

mode = 6;

}

}else if(nColSum < nRowSum){

ver = 1; // vertically dominant
// polarity
if((dblk[1] < 0 && dblk[8] < 0) || (dblk[1] > 0 && dblk[8] > 0)){

mode = 7;

}else{

mode = 5;

}

}
// diagonal orientation
if(nColSum == nRowSum){

if((dblk[1] < 0 && dblk[8] < 0) || (dblk[1] > 0 && dblk[8] > 0)){

mode = 3;

}else{

mode = 4;

}

}
if(std_dev < 5)

mode = 2;

if(ver && (angle < 12 || angle > 80))

mode = 0;

else if(hor && (angle > 80 || angle < 12))

mode = 1;

For inter-coded MBs, if the variance of a block is small (e.g., less then 25), the block need not be broken up into sub-blocks for motion estimation. The mean and variance of the MC residual can be used for inter-MB transcoding. For blocks with larger variance, the blocks can be divided into sub-blocks, and the variance of the sub-blocks can be used to estimate the need for further division into sub-blocks. This approach eliminates motion estimation for a large number of block sizes, thereby substantially reducing the motion estimation complexity. The motion vectors obtained from the decoding process are indicative of regions where optimal prediction can be found.

This approach can also be extended to multi-frame motion estimation by examining the motion vectors of the corresponding blocks of successive frames. One way to reduce the multi-frame motion estimation complexity is to limit motion estimation to the regions of the reference frames pointed to by the decoded motion vectors. Additionally, a smaller search range can be utilized. These approaches can reduce the motion estimation complexity significantly.

The H.264 video coding standard, in particular, is flexible and offers a number of tools to support a range of applications with very low as well as very high bit rate requirements. Compared with MPEG-2 video, for instance, the H.264 video format provides video that is perceptually equivalent at one-third to one-half the bit rate of the MPEG-2 video. These gains, however, are obtained through increased encoding and decoding complexity. If optimization features are incorporated, an H.264 video encoder can be 10 times more complex as an MPEG-2 video encoder.

The tools used in H.264 coding make transcoding of H.264 using conventional techniques commensurately more complex. The system and method of the present invention reduce the transcoding complexity by utilizing the by-product of decoding. As described above, for example, in decoding an MPEG-2 video file, DCT coefficients are obtained and used to determine or select the MB modes.

The MB coding mode computation process in H.264 encoding is computationally intensive. For intra-coded frames, all MBs are typically intra-coded. For inter-coded frames, an MB could be inter- or intra-coded, making the mode decision for inter-frames accordingly more resource demanding. For intra-mode prediction, the decision making process has to evaluate prediction modes for each of the 16 4×4 blocks (or four 8×8 blocks).

With respect to inter-coded frames, an MB has to be evaluated for intra-coding and inter-coding. The final coding mode is determined by evaluating rate-distortion tradeoffs. For inter-coding the number of candidate predicators and prediction modes that have to be evaluated are significantly higher, and the options and complexities increase proportionately with the number of reference frames used. The present invention, as already described, significantly reduces these complexities and their attendant problems by taking advantage of the availability of DCT coefficients and, as also already described, using the DCT coefficients to determine the MB prediction mode. This obviates the need to resort to the H.264 MB mode prediction process, which as already noted is computationally intensive.

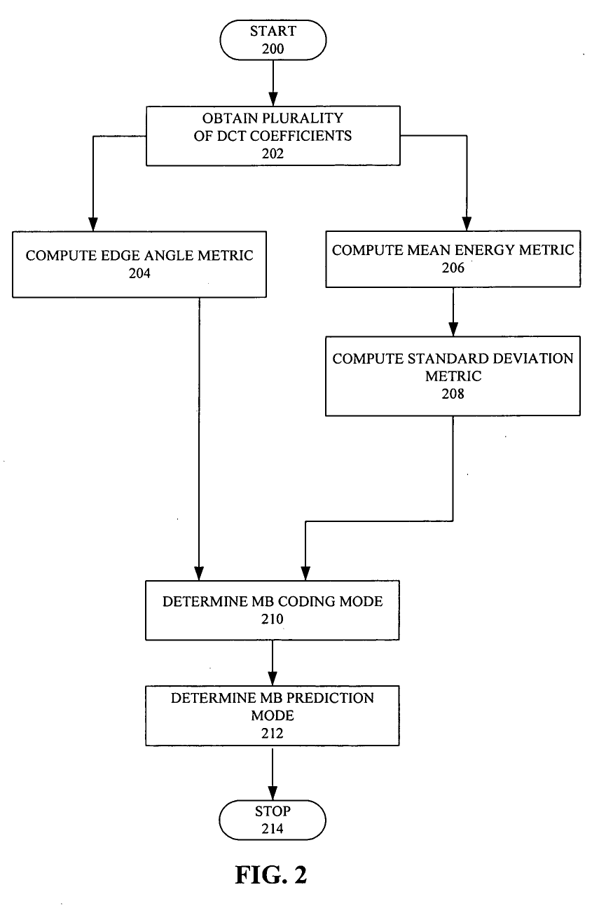

FIG. 2 provides a flowchart illustrative of a method 200 of selecting both an intra-MB coding mode and an MB prediction mode, according to yet another embodiment of the present invention. The method 200 includes at step 202 obtaining a plurality of DCT coefficients. The plurality of DCT coefficients can be obtained, according to one embodiment, as the result of decoding a compressed data file, such as a video file encoded according the MPEG-2 standard.

The method further includes, at step 204, computing an edge angle metric. The edge angle metric is illustratively computed based upon the DCT coefficients as described above. The method further includes, at step 206, independently determining a mean energy metric based on the DCT coefficients obtained at step 202 and according to the calculations also described above. Additionally, a standard deviation metric, which illustratively is also computed based upon the plurality of DCT coefficients, is determined at step 208.

The method continues at step 210 with the determination, or selection, of an MB coding mode based upon the mean energy metric and the standard deviation metric. More particularly, for each MB, the standard deviation of the DC coefficient representing the average energy of a video block is computed. The corresponding actual mode dictated by the H.264 or other standard is computed for each MB for a given quantization parameter (QP). The standard deviation threshold is selected such that the threshold-based decision (i.e., for selecting a mode) minimizes mismatches with the decision dictated by the H.264 or other standard.

The method illustratively continues at step 212. At step 212, the MB prediction mode is similarly selected or determined, as described above, based upon the edge angle metric computed in the preceding step 206. The method 200 illustratively concludes at step 214.

Although illustratively the MB coding mode and MB prediction mode are determined jointly, according to alternative embodiments only the MB coding mode or MB prediction mode is determined or selected. Specifically, according to one embodiment, the MB coding mode is determined based upon the mean energy and standard deviation metrics computed on the basis of the obtained plurality of DCT coefficients. In an alternative embodiment, the MB prediction mode is determined or selected based upon the edge angle metric computed on the basis of the obtained plurality of DCT coefficients.

The DCT coefficients can be used to estimate the relative activity in blocks and to determine whether a 16×16 or 4×4 coding mode should be used. Alternatively, a sum of absolute differences can be used for selecting the best 16×16 and the best 4×4 prediction modes in order to make a final decision. To compute MB coding modes for the 16×16 and 4×4 blocks, the DCT of the 16×16 and 4×4 blocks can be computed from the 8×8 DEC blocks using the DCT combination and segmentation approach proposed in J. Jiang and G. Feng, “The Spatial Relationship of DCT Coefficients Between a Block and Its Sub-blocks,” IEEE Transactions On Signal Processing, Vol. 50, No. 5, pp. 1160-1169 (May 2002), incorporated herein in its entirety.

Reusing MPEG-2 MB modes can also reduce complexity. An intra-MB in MPEG-2 can be coded as intra-MB in H.264. While an MPEG-2 intra-mode MB may have non-intra counterparts in H.264 coded video, it is less likely that MPEG-2 non-intra MB has an intra counterpart in H.264 coded video.

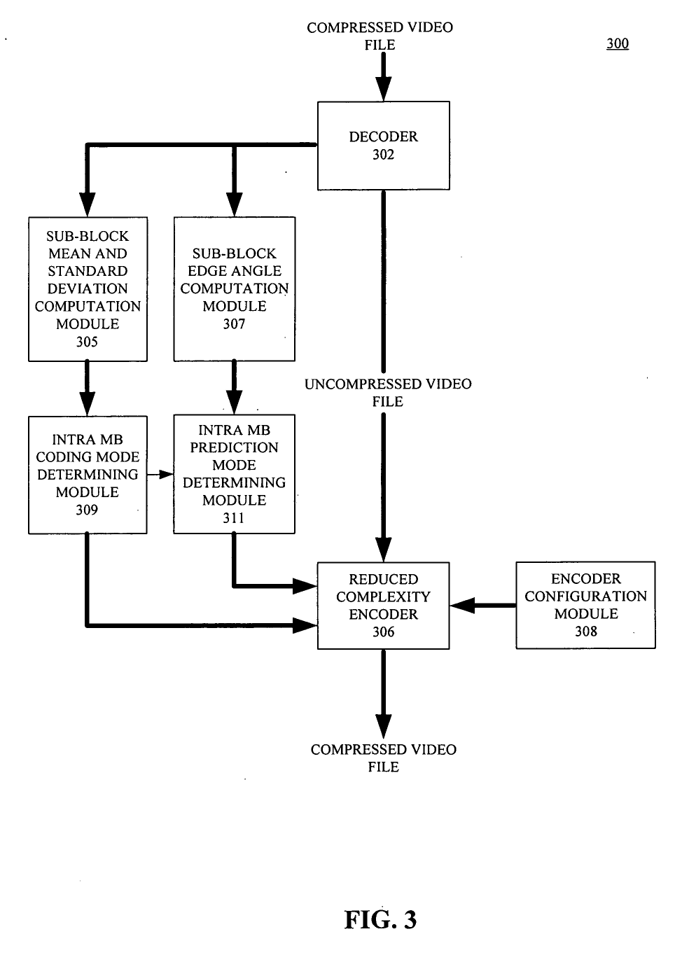

An alternative system for selecting both an intra-MB coding mode and an MB prediction mode, according to still another embodiment of the present invention, is illustrated by the block diagram in FIG. 3. The system 300 illustratively includes a decoder 302 for receiving a compressed video file. The system 300 further illustratively includes a sub-block mean and standard deviation computation module 305 and a sub-block edge angle computation module 307 each communicatively linked to the decoder 302. Additionally, the system 300 illustratively includes an intra-MB coding mode determining module 309 communicatively linked to the sub-block mean and standard deviation determining module 305. The system 300 also illustratively includes an intra-MB prediction mode determining module 311 communicatively linked to the sub-block edge angle determining module 307. The system 300 further illustratively includes a reduced complexity encoder 306 for receiving outputs from the sub-block mean and standard deviation computation module 305 and the sub-block edge angle computation module 307 to which the reduced complexity encoder is communicatively linked. The system 300 also illustratively includes an encoder configuration module 308 communicatively linked to the reduced complexity encoder 306.

Operatively, the decoder 302 decodes the received compressed video file to yield an uncompressed video file. A by-product of the decoding performed by the decoder 302 is a plurality of DCT coefficients which are obtained, respectively, by the sub-block mean and standard deviation computation module 305 and the sub-block edge angle computation module 307 each communicatively linked to the decoder 302. The sub-block mean and standard deviation computation module 305 computes a mean metric and a standard deviation metric based upon DCT coefficients obtained from the decoder module 302. In parallel, the sub-block edge angle computation module 307 computes an edge angle computation metric also based upon DCT coefficients obtained from the decoder module 302. Based on the mean and standard deviation metrics computed by the sub-block mean and standard deviation computation module 305, the intra-MB coding mode determining module 309 selects or determines an intra-MB coding mode. The intra-MB prediction mode determining module 311 selects or determines an MB prediction mode based upon the edge angle metric computed by the sub-block edge angle computation module 307. With the proper modes efficiently determined by the respective determining modules, the encoder 306 can encode the uncompressed video file to generate a newly compressed video file according to the configuration standard supplied by the configuration module 308.

Similar to intra-mode estimation, the DCT coefficients can be used to reduce the coding mode options in inter-frame coding. One approach to determining an inter-MB coding mode uses the DCT coefficients of the MC residual to determine the variable block size for motion estimation. Higher activity or a larger number of non-zero DCT coefficients indicate a higher level of detail and possibly warrants a smaller block size. The MPEG-2 motion vectors, for example, can be used to estimate regions to find best matches. The object motion indicated by the motion vectors of a block in successive frames can be used to select candidate reference frames. The motion vectors in MPEG-2 B-frames can be similarly used to reduced the number of candidate reference pictures.

Determining an inter-MB coding mode uses the DCT coefficients of the MC residual to determine the variable block size for motion estimation. More particularly, the inter-MB coding mode is determined on the basis of the mean and variance of the MC residuals. The mean and variance are used in the same manner as the above-described decision process whereby the mean and variance metrics are compared to predetermined thresholds.

According to one embodiment, the MB coding mode for the inter-MBs are computed using the MC residual of the MPEG-2 inter-MBs. The DCT of the MC residual and the MC residual, after obtaining or computing inverse DCTs, for an MB can be obtained during the MPEG-2 decoding stage. The MC residual can be used to compute the MB coding mode for the H.264 encoding stage. The inter-MB coding mode is illustratively determined by first computing the mean and variance metrics, though other metrics can be used, of the MC residuals. For example, the mean and variance of 16 4×4 sub-blocks of a 16×16 luma block are computed. Next the MPEG-2 MB coding modes and map are employed. Specifically, the MEG-2 intra-MB is coded as an H.264 intra-MB. MPEG-2 MB in skip mode is coded as H.264 MB in skip mode. For non-intra MBs, the mean and variance of the MC residual are compared to determine whether a MB is skipped or coded. If an MB is not skipped, the mean and variance of the sub-blocks with pre-determined threshold values are compared to obtain a MB coding mode. Using the computed MB coding mode and the MPEG-2 motion vector as a seed, motion vectors for the selected H.264 MB mode are computed.

The following pseudo-code provides an exemplary procedure of comparing the mean and variance of a 4×4 block of MC residuals to predetermined thresholds to determine an inter 16×16 mode:

if(mean[5] <= 8.625){

if(variance[6] <= 12.734375){

if(mean[10] <= 6.125){

if(mean[1] <= 7.0625){

if(mean[14] <= 4.8125){

return 1; // MB coding mode is: inter 16x16

}

}

}

}

}

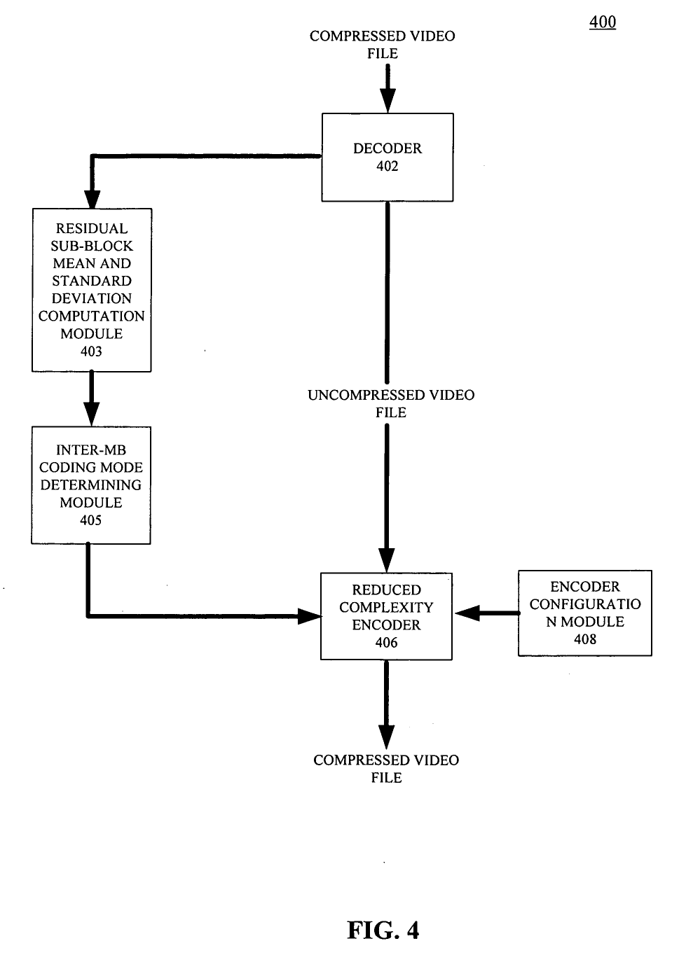

FIG. 4 is a block diagram of a system for determining an inter-MB mode based on the described procedure for computing the MB coding mode for the inter-MBs. The system 400 illustratively includes a video decoder 402 for receiving a compressed video file. The system 400 further illustratively includes a residual sub-block mean and standard deviation computation module 403 communicatively linked to the video decoder 402 and an inter-MB coding mode determining module 405 communicatively linked to the residual sub-block mean and standard deviation computation module. Additionally, the system 400 illustratively includes a video encoder 406 communicatively linked to the video decoder 402 and the inter-MB coding mode determining module 405. The system also illustratively includes an encoder configuration module 408.

Operatively, the video decoder 102 receives a compressed video file and decompresses the video file so as to generate an uncompressed video file. The video decoder 402 in generating the uncompressed video file also generates a plurality of DCT coefficients, as already described. The residual sub-block mean and standard deviation computation module 403 generates mean and standard deviation metrics based on the plurality of DCT coefficients obtained from the video decoder 402. The inter-MB coding mode determining module 405 determines or selects an inter-MB coding mode according to the above-described procedures based upon the mean and standard deviation metrics. The video encoder 406 encodes the uncompressed video file based on the determined inter-MB coding mode in accordance with a coding standard supplied by the encoder configuration module 408.

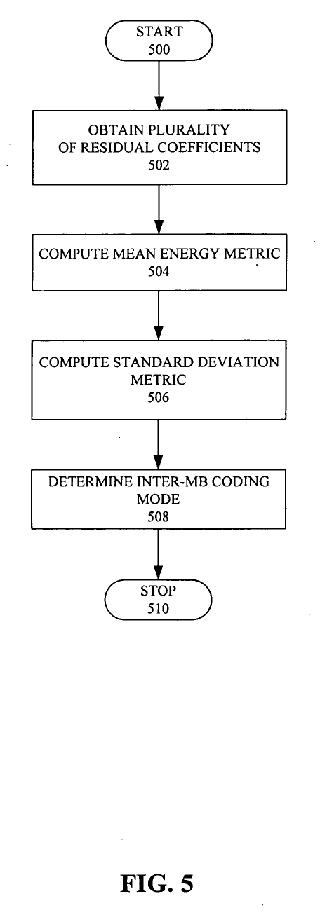

FIG. 5 is a flowchart comprising the exemplary steps of a method of determining an inter-MB coding mode according to yet another embodiment of the invention. The method 500 includes, at step 502, obtaining a plurality of coefficients. At step 504, the method 500 continues with the computing of a mean energy metric based upon the plurality of coefficients obtained. The method 500 further includes, at step 506 computing a standard deviation metric also based upon the plurality of coefficients obtained.

The method 500, at step 508, additionally includes determining or selecting an inter-MB coding mode based upon the computed mean energy and standard deviation metrics. More particularly, for each MB, the mean and standard deviation of the residuals of a video block, specified by an encoder such as the MPEG-2 video coding standard, is computed. For each corresponding MB, a decision dictated by an encoder standard, such as the H.264 standard, is computed for a given quantization parameter (QP). A corresponding threshold is the threshold that maximizes matches with the decisions (i.e., selecting the modes) dictated by the encoder standard, such as the H.264 standard. The method illustratively concludes at step 510.

According to one embodiment, the step 502 of obtaining a plurality of coefficients comprises obtaining a plurality of DCT coefficients generated by the decoding of a compressed video file, as earlier described. According to an alternative embodiment, the plurality of coefficients can comprise a plurality of residuals. More particularly, the compressed video file can be a video file encoded according to the MPEG-2 standard. The DCT of MC residuals and the MC residuals, after performing an inverse DCT, for an MB can be obtained by decoding the MPEG-2 video file.

The present invention can be realized in hardware, software, or a combination of hardware and software. The present invention can be realized in a centralized fashion in one computer system, or in a distributed fashion where different elements are spread across several interconnected computer systems. Any kind of computer system or other apparatus adapted for carrying out the methods described herein is suited. A typical combination of hardware and software can be a general purpose computer system with a computer program that, when being loaded and executed, controls the computer system such that it carries out the methods described herein.

The present invention also can be embedded in a computer program product, which comprises all the features enabling the implementation of the methods described herein, and which when loaded in a computer system is able to carry out these methods. Computer program in the present context means any expression, in any language, code or notation, of a set of instructions intended to cause a system having an information processing capability to perform a particular function either directly or after either or both of the following: a) conversion to another language, code or notation; b) reproduction in a different material form.

This invention can be embodied in other forms without departing from the spirit or essential attributes thereof. Accordingly, reference should be made to the following claims, rather than to the foregoing specification, as indicating the scope of the invention.

That claimed is:

1. A method of determining an inter-macroblock (MB) coding mode for encoding a video file, the method comprising:
obtaining a plurality of coefficients by decoding a compressed video file;
computing a mean energy metric based upon the plurality of coefficients;
computing a standard deviation metric based upon the plurality coefficients; and
determining the MB coding mode based upon the mean energy and standard deviation metrics.

2. The method of claim 1, wherein the step of obtaining a plurality of coefficients comprises obtaining a plurality of discrete cosine transformation (DCT) coefficients.

3. The method of claim 2, wherein the DCT coefficients are obtained by decoding a compressed video file encoded according to a DCT-based video coding algorithm.

4. The method of claim 1, wherein the step of obtaining a plurality of coefficients comprises obtaining a plurality of motion-compensated (MC) residuals.

5. The method of claim 4, wherein the plurality of MC residuals obtained comprise a plurality of compensated residual of inter-MBs determined according to a DCT-based video coding standard.

6. The method of claim 1, wherein the plurality of coefficients comprises a plurality of discrete cosine transformation (DCT) coefficients, and wherein the step of computing a mean energy metric comprises computing a value μ equal to
$$μ = \frac{1}{{n}^{2}} {\sum }_{0}^{n - 1} {\sum }_{0}^{n - 1} f ( x , y ) = \frac{F ( 0 , 0 )}{n} + K ,$$
where F(0,0) is the (0,0)-th DCT coefficient and f(x,y) is the (x,y)-th pixel of the sub-block of a corresponding MB.

7. The method of claim 1, wherein the plurality of coefficients comprises a plurality of discrete cosine transformation (DCT) coefficients, and wherein the step of computing a standard deviation comprises computing a value σ₂ equal to
$${σ}^{2} = \frac{1}{{n}^{2}} {\sum }_{u = 0}^{n - 1} {\sum }_{v = 0}^{n - 1} {F ( u , v )}^{2} , ( u , v ) \neq ( 0 , 0 ) ,$$
where each F(u,v) designates a corresponding one of the plurality of DCT coefficients.

8. The method of claim 1, wherein the step of determining the inter-MB coding mode comprises comparing the mean energy metric and the standard deviation metric to a plurality of predetermined threshold values.

9. A method of determining an intra-macroblock (MB) coding mode for encoding a video file, the method comprising:
obtaining a plurality of discrete cosine transformation (DCT) coefficients by decoding a compressed video file;
computing a mean energy metric based upon the plurality of DCT coefficients;
computing a standard deviation metric based upon the plurality of DCT coefficients; and
determining the MB coding mode based upon the mean energy and standard deviation metrics.

10. The method of claim 9, wherein the step of obtaining a plurality of coefficients comprises obtaining a plurality of discrete cosine transformation (DCT) coefficients.

11. The method of claim 10, wherein the DCT coefficients are obtained by decoding a compressed video file encoded according to a DCT-based video coding algorithm.

12. The method of claim 10, wherein the step of computing a mean energy metric comprises computing a value μ equal to
$$μ = \frac{1}{{n}^{2}} {\sum }_{0}^{n - 1} {\sum }_{0}^{n - 1} f ( x , y ) = \frac{F ( 0 , 0 )}{n} + K ,$$
where F(0,0) is the (0,0)-th DCT coefficient and f(x,y) is the (x,y)-th pixel of the sub-block of a corresponding MB.

13. The method of claim 10, wherein the step of computing a standard deviation comprises computing a value σ equal to
$${σ}^{2} = \frac{1}{{n}^{2}} {\sum }_{u = 0}^{n - 1} {\sum }_{v = 0}^{n - 1} {F ( u , v )}^{2} , ( u , v ) \neq ( 0 , 0 ) ,$$
where each F(u,v) designates a corresponding one of the plurality of DCT coefficients.

14. The method of claim 10, wherein each DCT coefficient comprises a full DCT coefficient, and further comprising determining at least one full DCT coefficient based upon a motion-compensated DCT manipulation.

15. The method of claim 10, wherein each DCT coefficient comprises a full DCT coefficient, and further comprising determining at least one full DCT coefficient based upon a corresponding pixel reconstruction.

16. The method of claim 9, wherein the step of determining the intra-MB coding mode comprises comparing the mean energy metric and the standard deviation metric to a plurality of predetermined threshold values.

17. A method of determining an intra-macroblock (MB) prediction mode for encoding a video file, the method comprising:
obtaining a plurality of coefficients by decoding a compressed video file;
computing an edge angle metric based upon the plurality of coefficients; and
determining the intra-MB prediction mode based upon the edge angle metric.

18. The method of claim 17, wherein the step of obtaining a plurality of coefficients comprises obtaining a plurality of discrete cosine transform (DCT) coefficients.

19. The method of claim 17, wherein the DCT coefficients are obtained by decoding a compressed video file encoded according to a DCT-based video coding algorithm.

20. The method of claim 17, wherein the step of computing an edge angle comprises computing a value θ equal to
$$tan θ = \frac{{\sum }_{u = 1}^{n} \vert F ( u , 0 ) \vert}{{\sum }_{v = 1}^{m} \vert F ( 0 , v ) \vert} ,$$
wherein each F(u,v) designates a corresponding one of the plurality of DCT coefficients.

21. A system for transcoding a video file, the system comprising:
a video file decoder for generating an uncompressed file segment based upon a received compressed video file compressed according to a first data compression standard;
at least one macroblock (MB) determining module for determining an MB mode based upon at least one of a plurality of coefficients generated by the decoding of the compressed video file; and
a video file encoder for compressing the uncompressed file segment according to a second data compression standard based upon the determined MB mode.

22. The system of claim 21, wherein the MB determining module comprises at least one of an inter-MB coding mode determining module and an inter-MB prediction mode determining module.

23. The system of claim 21, wherein the MB determining module comprises an inter-MB coding mode determining module configured to determine a coding mode based upon a computed mean energy metric and a standard deviation metric.

24. The system of claim 21, wherein the MB determining module comprises an inter-MB prediction mode determining module configured to determine a prediction mode based upon a computed edge angle metric.

25. The system of claim 21, wherein the MB determining module comprises an intra-MB prediction mode determining module configured to determine a prediction mode based upon a mean energy metric and a standard deviation metric.
